(19) United States
(12) Patent Application Publication
(10) Pub. No.: US 2015/0199012 A1
(43) Pub. Date: Jul. 16, 2015

(54) METHOD AND APPARATUS FOR PROVIDING A HAPTIC FEEDBACK TO A ROTARY KNOB

(71) Applicant: Symbol Technologies, Inc., Schaumburg, IL (US)

(72) Inventor: MARK C. PALMER, ASTORIA, NY (US)

(73) Assignee: SYMBOL TECHNOLOGIES, INC., SCHAUMBURG, IL (US)

(21) Appl. No.: 14/156,874

(22) Filed: Jan. 16, 2014

(51) Int. Cl. G06F 3/01; G06F 3/0487; G06F 3/0485

(52) U.S. Cl. CPC G06F 3/016; G06F 3/0485; G06F 3/0487

(57) ABSTRACT

A method and apparatus for providing a haptic feedback to a rotary knob is provided herein. During operation the rotary knob will be rotated, causing a display to cycle through menu items. A haptic feedback is provided to the rotary knob in order to identify a border (transition) between menu items. During operation a different haptic effect may be provided to different borders in order to distinguish between menu items. In addition, an angle of rotation for a particular menu is allowed to vary prior to a border being encountered. Because both the haptic effect and the angle of rotation for the rotary knob is allowed to vary, a user may be able to easily identify transitions to various menu items.

### FIELD OF THE INVENTION

The present invention generally relates to providing haptic feedback to a user, and more particularly to a method and apparatus for providing a haptic feedback to a rotary knob.

### BACKGROUND OF THE INVENTION

As mobile devices incorporate more features, it is increasingly desirable to enable features such as knobs with multiple functions to handle the load and offer the user a way to interact with the features blindly. However, using such a knob must allow the user to easily differentiate between modes of operation. Therefore, it would be desirable to have a device rotary knob that is capable of providing a feedback to a user, the feedback identifying specific menu items or device functions.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a device having a haptic knob.

FIG. 2 shows operation of the device of FIG. 1.

FIG. 3 illustrates a haptic effect when rotating a knob between menu items.

FIG. 4 illustrates a preferred menu item existing on the device of FIG. 1.

FIG. 5 illustrates a haptic effect versus angle plot for the device shown in FIG. 1.

FIG. 6 illustrates the haptic effect versus angle shown in FIG. 4 as applied to the knob of FIG. 1.

FIG. 7 is a block diagram of the device shown in FIG. 1.

FIG. 8 is a flow chart showing operation of the device of FIG. 6.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for providing a haptic feedback to a rotary knob is provided herein. During operation the rotary knob will be rotated, causing a display to cycle through menu items or device functions. A haptic feedback is provided to the rotary knob in order to identify a border (transition) between menu items. During operation a different haptic effect may be provided to different borders in order to distinguish between menu items. In addition, an angle of rotation for a particular menu is allowed to vary/change prior to a border being encountered. The angle can be based on the particular menu item. Because both the haptic effect and the angle of rotation for the rotary knob is allowed to vary, a user may be able to easily identify transitions to various menu items.

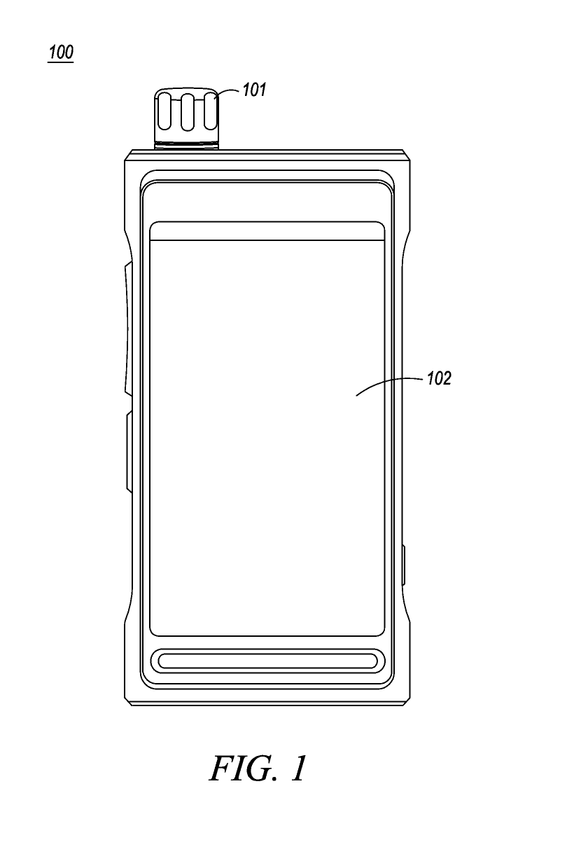

FIG. 1 illustrates device 100 having a haptic rotary knob. As shown, device 100 comprises graphical user interface (GUI) 102 and haptic rotary knob 101. In a preferred embodiment, GUI 102 comprises a man-machine interface such as a touch-screen. Rotary knob 101 allows the user to directly manipulate functions and settings of device 100. Knob 101 is approximately a cylindrical object. Knob 101 can alternatively be implemented as a variety of different objects, including conical shapes, spherical shapes, dials, cubical shapes, rods, etc., and may have a variety of different textures on their surfaces, including bumps, lines, or other grips, or projections or members extending from the circumferential surface.

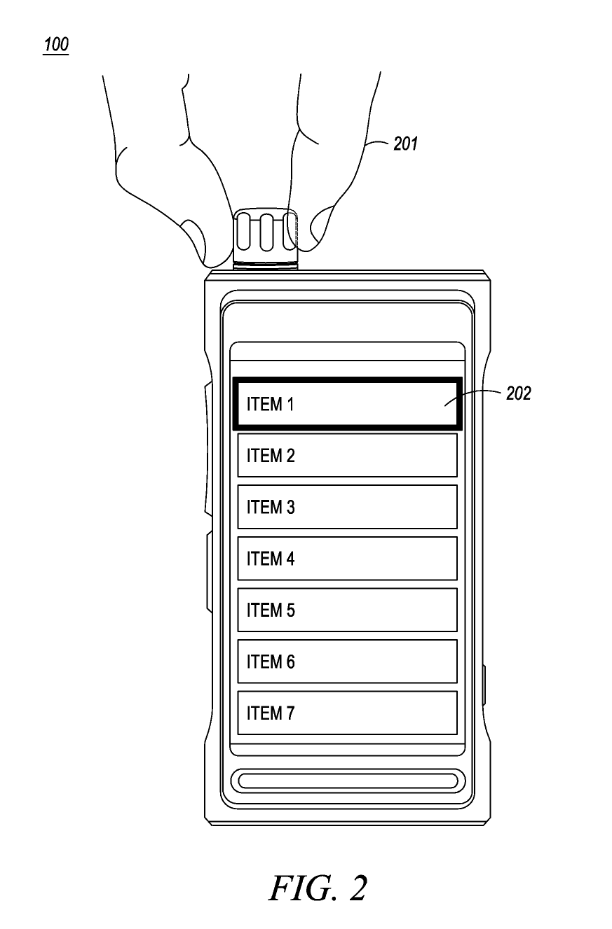

The user 201 (shown in FIG. 2) preferably grips or contacts the circumferential surface of knob 101 and rotates it a desired amount to scroll through menu items. Haptic feedback can be provided to distinguish between borders of menu items 202 (only one menu item labeled in FIG. 2). The Haptic feedback is preferably a tactile feedback which takes advantage of a sense of touch by applying forces, vibrations, or motions to the knob.

Menu items include any object that can be displayed to a user, including without limitation, text, web pages, digital images, icons, videos, animations and the like. For example, menu items such as “audio”, “map”, “temperature”, and “cellular phone” can be provided. Once knob 101 is rotated to highlight a menu item, a sub-menu for that item may be displayed by pushing knob 101. Therefore, knob 101 can then be rotated to cycle through a list of menu items 202, select a menu item 202 by pushing the knob, and adjust a value of the selected menu item by again rotating knob 101.

As discussed, knob 101 is preferably provided with haptic feedback to aide user 201 in scrolling through menu items 202 without the need to look at screen 102. That is, by adjusting the feel of the knob 101 to clearly correspond to the context of GUI 102, a user may navigate through menu items without the need to look at GUI 102.

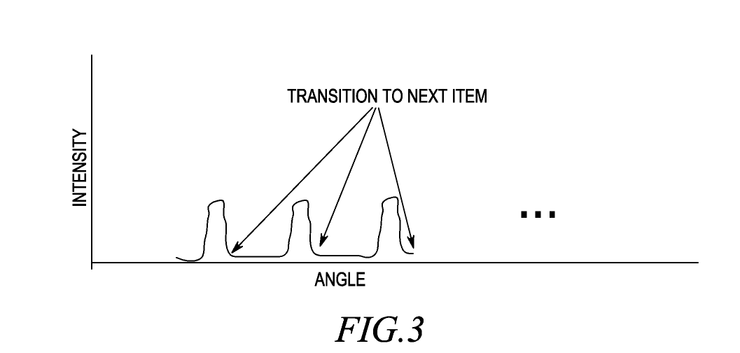

As discussed, the haptic feedback is particularly useful to distinguish the transition, or border, between menu items as knob 101 is rotated. This is illustrated in FIG. 3. More particularly, FIG. 3 illustrates a haptic effect when rotating a knob between menu items. In particular a graph is shown that plots an intensity of force, vibration, or motion applied to the knob versus angle of rotation for knob 101. As knob 101 is rotated, its angle increases. Little to no haptic effect (forces, vibrations, or motions) is provided to knob 101 until prior to a transition to a next menu item occurs. As knob 101 is rotated, and a next menu item is about to be selected, user 201 is notified of the transition by a haptic effect applied to knob 101. The intensity of the haptic effect (e.g., an amount of force, vibration, or motion) increases as the border between menu items is reached. As shown in FIG. 3, once the transition to a next menu item is made, the haptic effect is reduced until a next menu-item border is reached.

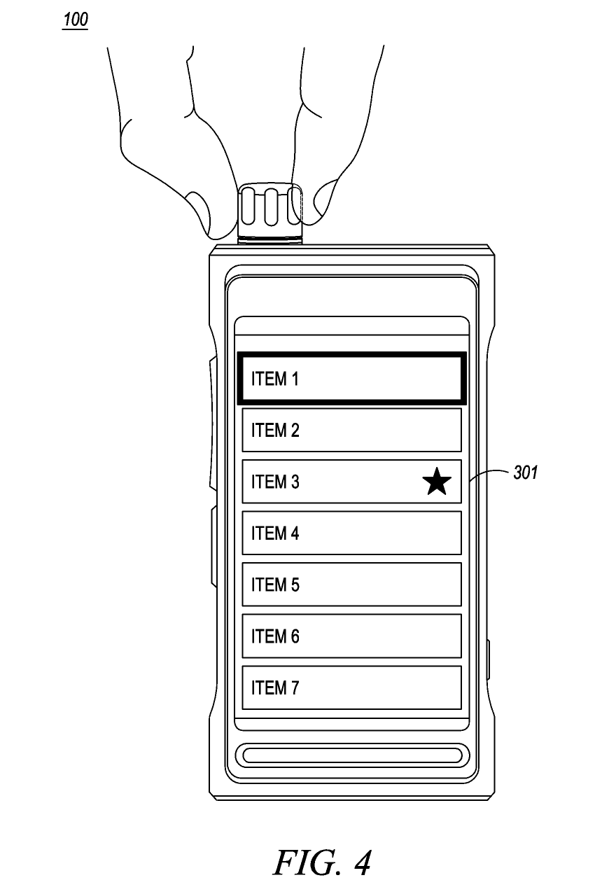

In one embodiment of the present invention, menu items may be given different importance. For example, a menu item may be “starred” to indicate a higher importance. This is illustrated in FIG. 4 where menu item 3 is given a higher importance. Higher-importance menu items may be marked by GUI 102, for example, by star 301. As discussed above, a different haptic effect may be provided to different menu-item borders in order to distinguish between select menu items. In addition, the angle of rotation between menu-item borders is allowed to vary in order to distinguish between menu items. Thus, for example, in FIG. 4, the border between menu item 2 and menu item 3 may be identified with a different haptic effect than, for example, the border between menu item 1 and menu item 2. In addition, knob 101 may only need to be rotated a first amount (angle) to transition from menu item 1 to menu item 2, but may need to be rotated a second amount to transition from menu item 3 to menu item 4. Because both the haptic effect and the angle of rotation for the rotary knob is allowed to vary, a user may be able to easily identify transitions to various menu items.

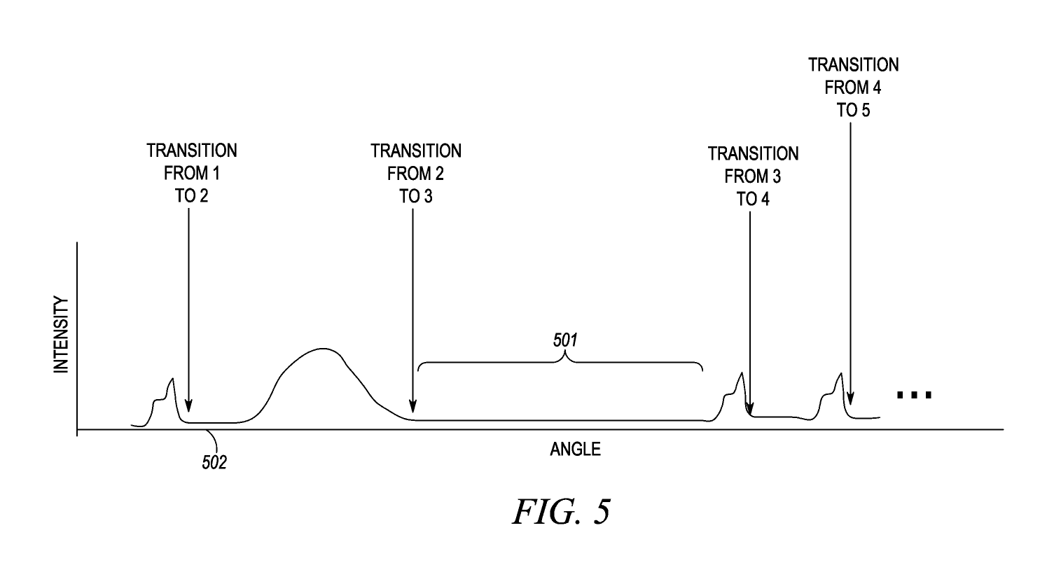

FIG. 5 illustrates a haptic effect versus angle plot for the device shown in FIG. 1. More particularly, the graph of FIG. 5 illustrates how the haptic intensity being applied to knob 101 changes as the knob is rotated. As is evident, different haptic effects may be applied to different menu-item border transitions. As shown in FIG. 5, the haptic effect when transitioning from menu item 2 to menu item 3 varies greatly from all other border transitions. Additionally, the angle of rotation 501 needed to transition through menu item 3 is greater than the rotation 502 needed to transition through any other menu item.

Thus, when a special, favorite, starred, or landmark menu item is rolled over, the haptic signature (i.e., the intensity of the forces, vibrations, or motions with respect to time and/or rotation angle) could be differentiated at the border region in order to indicate a transition to the menu item. In addition, that menu item could have a different ratio of knob rotation for scrolling. For instance a starred menu item may require 30 degrees of rotation to scroll off of, while all other menu items only require 15 degrees of rotation to scroll off of.

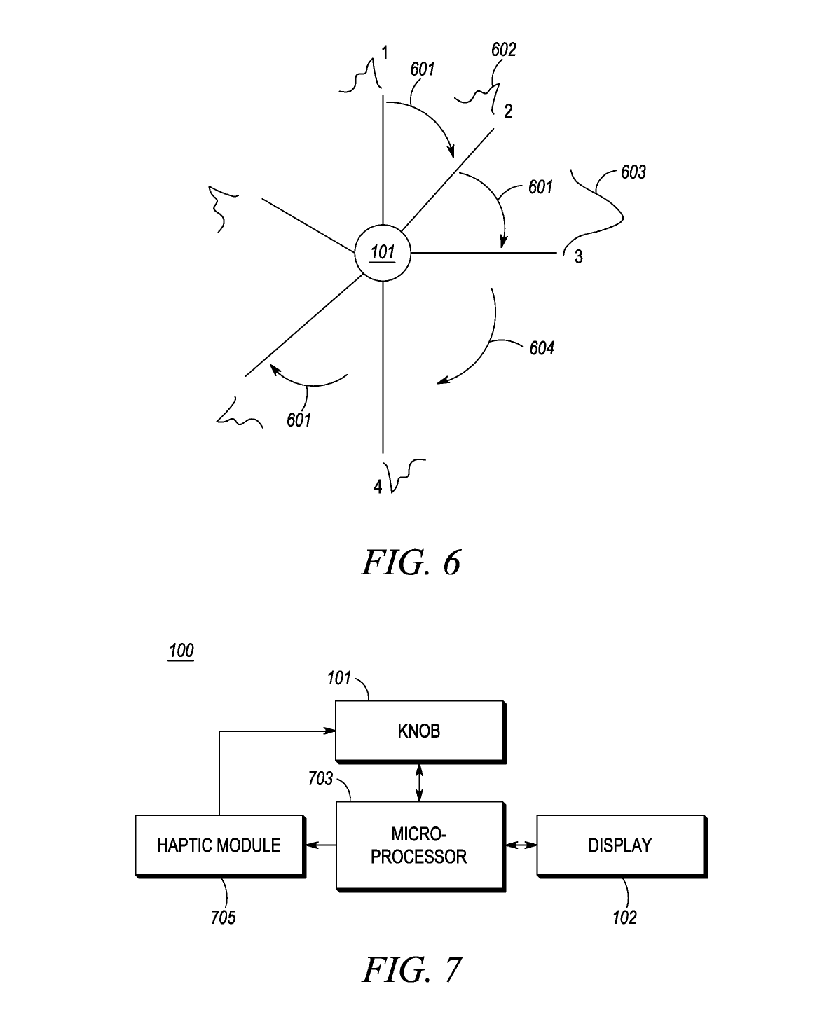

FIG. 6 illustrates the haptic effect versus angle shown in FIG. 5 as applied to the knob of FIG. 1. As knob 101 is rotated through first angle 601, a transition from menu item 1 to menu item 2 takes place. At the border of this transition, a first haptic effect 602 is applied to knob 101. As knob 101 continues to be rotated through another first angle 601, a transition from menu item 2 to menu item 3 takes place. At the border of this transition, a second haptic effect 603 is applied to knob 101. As knob 101 continues to be rotated through second angle 604, a transition from menu item 3 to menu item 4 takes place, again using the first haptic effect at the border.

FIG. 7 is a block diagram of the device shown in FIG. 1. As shown, device 100 comprises display 102, knob 101, microprocessor (logic circuitry) 703, and haptic module 705. Logic circuitry 703 comprises a digital signal processor (DSP), general purpose microprocessor, a programmable logic device, or application specific integrated circuit (ASIC) and is utilized to provide the functionality described below.

Knob 101 includes an internal sensor (not shown) as known in the art to provide position and direction information to logic circuitry 703 to communicate knob position for selection of menu items. Since the knob is preferably a continuous rotational device having an infinite range of rotational motion, an encoder, rather than continuous turn potentiometer, is a suitable sensor due to the encoder's accuracy and lower errors when transitioning between maximum and minimum values. Other types of sensors can, of course, be used in other embodiments, including magnetic sensors, analog potentiometers, etc.

Haptic module 705 provides various haptic effects (such as vibration) to knob 101 that can be perceived by the user. If the haptic module 705 generates vibration as a haptic effect, the intensity and the pattern of vibration generated by the haptic module 705 may be altered in various manners as discussed above. Haptic module 705 may provide various haptic effects, other than vibration, as long as the haptic effect can be varied for differing menu item transitions. These include, but are not limited to, a haptic effect obtained using a pin array that moves perpendicularly to a contact skin surface, a haptic effect obtained by injecting or sucking in air through an injection hole or a suction hole, a haptic effect obtained by giving a stimulus to the surface of the skin, a haptic effect obtained through contact with an electrode, a haptic effect obtained using an electrostatic force, and a haptic effect obtained by realizing the sense of heat or cold using a device capable of absorbing heat or generating heat.

During operation, knob 101 outputs an angle of rotation to microprocessor 703. In response, microprocessor 703 instructs display 102 to adjust an image accordingly (i.e., cycle through menu items). Additionally, microprocessor 703 will determine if a border between menu items has been reached, and if so, microprocessor will instruct haptic module 705 to provide an appropriate haptic feedback to knob 101.

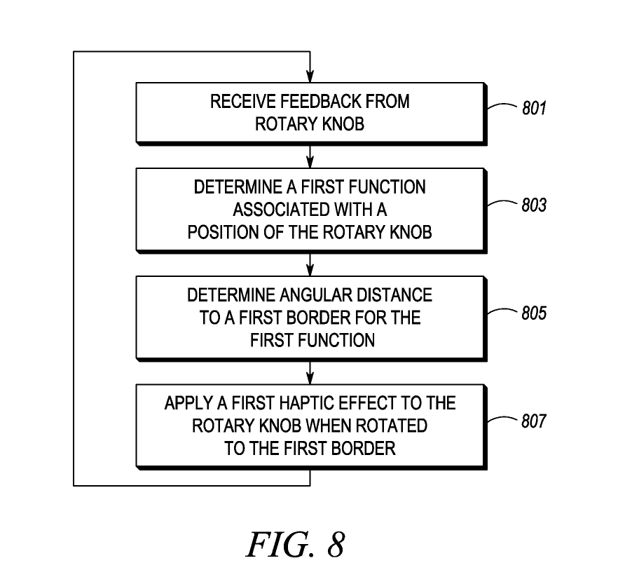

FIG. 8 is a flow chart showing operation of the device of FIG. 6. More particularly, the logic flow of FIG. 8 illustrates steps (not all steps are necessary) for providing a haptic effect to a rotary knob. The logic flow begins at step 801 where logic circuitry 703 receives feedback from rotating rotary knob 101 and determines an angle traveled for the rotary knob. At step 803 logic circuitry determines a first function associated with a position of the rotary knob. An angular distance to a first border for the first function is then determined by logic circuitry at step 805. At step 807 logic circuitry 703 instructs haptic module 705 to apply a first haptic effect to the rotary knob when rotated to the first border. As discussed above, the first haptic effect is based on the angle traveled, the first function, and the angular distance. The logic flow returns to step 801 where the process repeats.

The above logic flow allows for different border effects to be applied to different transitions between device functions. With this in mind, logic circuitry 703 may determine a second function associated with a position of the rotary knob, determining an angular distance to a second border for the second function, and instruct haptic module to apply a second haptic effect to the rotary knob when rotated to the second border. The second haptic effect based on the angle traveled, the second function, and the angular distance. As discussed above the first function differs from the second function, and the first haptic effect may differ from the second haptic effect. The difference between the two haptic effects may be in amplitude, shape, size, . . . , etc. In addition an angular distance that the knob rotates to pass through the first function may differ from an angular distance that the knob rotates to pass through the second function.

While the above description was given with the first and second function comprising menu items, one of ordinary skill in the art will recognize that any device function that may be manipulated with rotary knob 101 may have its border distinguished as described above. These functions may be taken from the group consisting of a menu item, a device operating parameter, a talkgroup, a channel, and a frequency. The current device function may be displayed on a graphical user interface (display) 102.

In the foregoing specification, specific embodiments have been described. However, one of ordinary skill in the art appreciates that various modifications and changes can be made without departing from the scope of the invention as set forth in the claims below. For example, while the embodiment provided above cycled through menu items, varying a haptic effect at the transition, one of ordinary skill in the art will recognize that any device function may be cycled through in a similar manner. For example a rotary know may be used to cycle through channels (frequencies/talkgroups) on a radio, with a different haptic effect given at the boundary/transitions between the channels. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing a haptic effect to a rotary knob, the method comprising the steps of:
receiving feedback from a rotating rotary knob;
determining an angle traveled for the rotary knob;
determining a first function associated with a position of the rotary knob;
determining an angular distance to a first border for the first function;
applying a first haptic effect to the rotary knob when rotated to the first border, the first haptic effect based on the angle traveled, the first function, and the angular distance.

2. The method of claim 1 further comprising the steps of:
determining a second function associated with a position of the rotary knob;
determining an angular distance to a second border for the second function;
applying a second haptic effect to the rotary knob when rotated to the second border, the second haptic effect based on the angle traveled, the second function, and the angular distance; and
wherein the first function differs from the second function, and the first haptic effect differs from the second haptic effect.

3. The method of claim 2 wherein the first and the second haptic effect differ in amplitude.

4. The method of claim 3 wherein the first and the second haptic effect differ in shape.

5. The method of claim 4 wherein an angular distance that the knob rotates to pass through the first function differs from an angular distance that the knob rotates to pass through the second function.

6. The method of claim 5 wherein the first and the second function comprise a function taken from the group consisting of a menu item, a device operating parameter, a talkgroup, a channel, and a frequency.

7. The method of claim 6 further comprising the step of:
displaying a current device function on a graphical user interface.

8. The method of claim 1 wherein the first and the second haptic effect differ in shape.

9. The method of claim 1 wherein an angular distance that the knob rotates to pass through the first function differs from an angular distance that the knob rotates to pass through the second function, wherein the angular distance is based on the identities of the first and the second function.

10. The method of claim 1 wherein the first and the second function comprise a function taken from the group consisting of a menu item, a device operating parameter, a talkgroup, a channel, and a frequency.

11. The method of claim 1 further comprising the step of:
displaying a current device function on a graphical user interface.

12. An apparatus comprising:
a rotary knob providing feedback;
logic circuitry receiving the feedback from a rotating rotary knob and determining an angle traveled for the rotary knob, determining a first function associated with a position of the rotary knob, determining an angular distance to a first border for the first function; and
a haptic module applying a first haptic effect to the rotary knob when rotated to the first border, the first haptic effect based on the angle traveled, the first function, and the angular distance.

13. The apparatus of claim 12 wherein:
the logic circuitry determines a second function associated with a position of the rotary knob, determines an angular distance to a second border for the second function; and
wherein the haptic module applies a second haptic effect to the rotary knob when rotated to the second border, the second haptic effect based on the angle traveled, the second function, and the angular distance; and
wherein the first function differs from the second function, and the first haptic effect differs from the second haptic effect.

14. The apparatus of claim 12 wherein the first and the second haptic effect differ in amplitude.

15. The method of claim 12 wherein the first and the second haptic effect differ in shape.
